(19) United States
(12) Patent Application Publication
(10) Pub. No.: US 2002/0183949 A1
(43) Pub. Date: Dec. 5, 2002

(54) System for dynamically monitoring the stability of semiconductor manufacturing equipment

(76) Inventors: Shun-An Chen, Kaohsiung (TW); Nai-Tien Ou, Hsinchu (TW); Ying-Wei Hsu, Hsinchu (TW)

Correspondence Address: BIRCH STEWART KOLASCH & BIRCH, PO BOX 747, FALLS CHURCH, VA, 22040-0747, US

(21) Appl. No.: 09/930,971

(22) Filed: Aug. 17, 2001

(30) Foreign Application Priority Data
May 31, 2001 (TW) 90113220

(51) Int. Cl. G06F 19/00; G01N 37/00

(52) U.S. Cl. 702/83

(57) ABSTRACT

A system for dynamically monitoring the stability of manufacturing equipment comprises a process executor requesting a plurality of semi-manufactured products processed by the manufacturing equipment to be inspected at a first sampling rate and receiving a plurality of inspection results, a data processor analyzing the inspection results from the process executor to determine a second sampling rate, a storage device storing the second sampling rate, and a controller receiving the second sampling rate from the storage device and changing the first sampling rate of the inspection requested by the process executor to the second sampling rate.

### BACKGROUND OF THE INVENTION

1. Field of the Invention

The present invention relates to semiconductor manufacturing equipment, particularly to a system for dynamically monitoring the stability of manufacturing equipment

2. Description of the Prior Art

In a semiconductor manufacturing process, the reliability of manufacturing equipment directly impacts the yield and quality of finished products. Reliability of equipment is monitored by monitor wafers at a sampling rate during production.

Stability of equipment performance is also important and must be monitored. Equipment is not released to production if the stability is not qualified.

Conventionally, stability of equipment is monitored by periodical stability evaluation wherein the equipment is withdrawn from production, then monitor wafers are processed by the equipment and statistical analysis of the results from the monitor wafers. The evaluation determines the sampling rate of the inspection during production. The more stable the performance of the equipment, the lower the sampling rate of the inspection.

However, the conventional stability monitoring method impacts the production capability due to the withdrawal of the manufacturing equipment. Besides, the sampling rate is fixed till the next evaluation since the stability is not monitored in real-time. The inspection step of the wafers in production is not controlled by the MES (Manufacturing Executive System) and is only initiated by a supervisor of the operator, thus the inspection step may be easily neglected.

### SUMMARY OF THE INVENTION

Therefore, the object of the present invention is to provide a system dynamically monitoring the stability of manufacturing equipment.

The present invention provides a system for dynamically monitoring stability of manufacturing equipment. The system comprises a process executor requesting a plurality of semi-manufactured products processed by the manufacturing equipment to be inspected at a first sampling rate and receiving a plurality of inspection results, a data processor analyzing the inspection results from the process executor to determine a second sampling rate, a storage device storing the second sampling rate, and a controller receiving the second sampling rate from the storage device and changing the first sampling rate of the inspection requested by the process executor to the second sampling rate.

In the present invention, the stability of the manufacturing equipment is monitored in real-time. The sampling rate of the inspection of the wafers in production is dynamically changed according to a current stability evaluation result. The inspection step is also controlled by the MES.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 is a diagram showing a system for dynamically monitoring stability of manufacturing equipment according to one embodiment of the invention.

FIG. 2 is a flowchart of a process procedure controlled by the MES according to one embodiment of the invention.

### DETAILED DESCRIPTION OF THE INVENTION

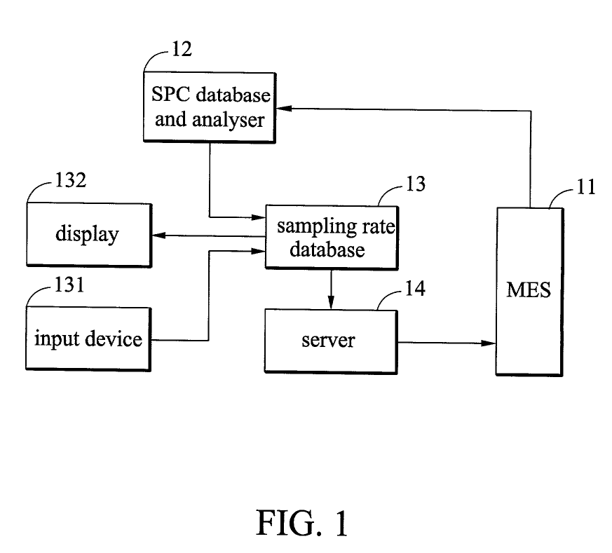

FIG. 1 is a diagram showing a system for dynamically monitoring stability of manufacturing equipment according to one embodiment of the invention. A system 1 comprises a MES 11, an SPC database and analyzer (a software application) 12, a sampling rate database 13, an input device 131 and a display 132 connected to the sampling rate database 13, and a server 14.

The MES 11 controls a process procedure by tracking each lot of semi-manufactured wafers and accordingly requesting implementation of each step in the process procedure. This allows the semi-manufactured wafers sent to the appropriate equipment to be processed or inspected.

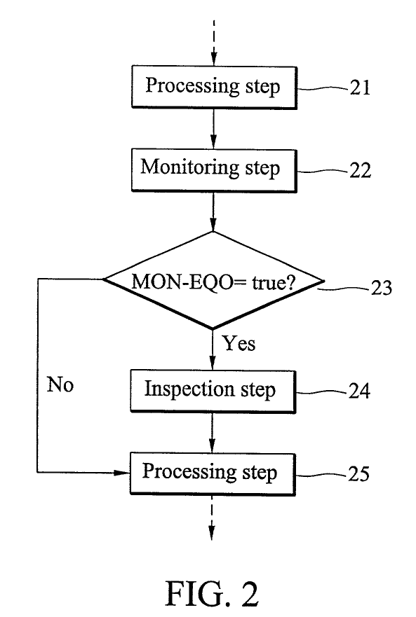

The process procedure controlled by the MES 11 is shown in FIG. 2.

Step 21 is a processing step, such as the formation of an oxide layer.

The next step 22 is a monitoring step immediately after the processing step to monitor equipment performance or stability.

In step 23, the MES 11 determines if step 24 should be implemented according to a value of MON-EQP. When the current lot of wafers must be inspected according to a sampling rate received from the server 14, the value of MON-EQP is true and the MES 11 determines whether step 24 should be implemented. Otherwise, if the value of MON-EQP is false, step 24 is neglected and step 25 is implemented.

Step 24 is an inspection step. The MES 11 requests the operator to carry out the inspection of the wafers have been processed in step 21 and receives the inspection results such as thickness of the oxide layer.

Step 25 is another processing step such as etching.

If the equipment for etching in step 25 is also to be monitored, steps 22, 23 and 24 are repeated, wherein the inspection results are, for example, depths of etching.

Please refer to FIG. 1 again, in which the SPC database and analyzer 12 pre-stores an initial sampling rate, receives and stores the inspection results from the MES 11, and analyzes the results to determine a new sampling rate. As previously described, the new sampling rate will be lower than the initial one when the stability of the monitored equipment is found to have increased, otherwise the new sampling rate will be higher.

The sampling rate database 13 stores the sampling rate (initial or newly determined) received from the SPC database and analyzer 12. Alternatively, the sampling rate database 13 receives another new sampling rate directly from the operator through the input device 131 and replacing the sampling rate from the SPC database and analyzer 12. The display 132 displays the current sampling rate to the operator.

The server 14 reads the sampling rate from the sampling rate database 13 and sends it to the MES 11 to change the current sampling rate according to which the MES 11 requests the inspection of the processed wafers.

In the present invention, the stability of the manufacturing equipment is monitored in real-time. The sampling rate of the inspection of the wafers in production is dynamically changed according to a current stability evaluation result. The inspection step is also controlled by the MES. This eliminates the drawbacks of the conventional monitoring method.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A system for dynamically monitoring stability of manufacturing equipment, comprising:
a process executor requesting a plurality of semi-manufactured products processed by the manufacturing equipment to be inspected at a first sampling rate and receiving a plurality of inspection results;
a data processor analyzing the inspection results from the process executor to determine a second sampling rate;
a device storing the second sampling rate; and
a controller receiving the second sampling rate from the storage device and changing the first sampling rate of the inspection requested by the process executor to the second sampling rate.

2. The system as claimed in claim 1 further comprising an input device connected to the storage device for inputting of a third sampling rate, wherein the controller receives the third sampling rate from the storage device and changes the first sampling rate of the inspection of the processed semi-manufactured products guided by the process executor to the third sampling rate.

3. The system as claimed in claim 1, further comprising a display connected to the storage device, displaying the first and the second sampling rates.

4. The system as claimed in claim 1 wherein the manufacturing equipment etches the semi-manufactured products.

5. The system as claimed in claim 1 wherein the manufacturing equipment forms an oxide layer on the semi-manufactured products.

6. The system as claimed in claim 1 wherein the process executor is a Manufacturing Executive System.

7. The system as claimed in claim 1 wherein the inspection of the semi-manufacturing products is nondestructive.

8. The system as claimed in claim 1 wherein one of the semi-manufactured products is a semi-manufactured semiconductor device.

9. The system as claimed in claim 8 wherein the semiconductor device is a wafer.

10. The system as claimed in claim 1 wherein one of the inspection results is a thickness of an oxide layer.

11. The system as claimed in claim 1 wherein one of the inspection results is an etching depth.

12. The system as claimed in claim 1 wherein the data processor is an SPC analyzing software application.

13. The system as claimed in claim 1 wherein the controller is a server.
